(19) United States
(12) Patent Application Publication
(10) Pub. No.: US 2025/0335621 A1
(43) Pub. Date: Oct. 30, 2025

(54) BUTLER DATA CONTROL

(71) Applicant: Grey Market Labs, PBC, Arlington, VA (US)

(72) Inventors: Kristopher P. Schroeder, Falls Church, VA (US); Timothy R. Underwood, Burke, VA (US); Nyla S. Khalil, Falls Church, VA (US)

(21) Appl. No.: 19/191,421

(22) Filed: Apr. 28, 2025

Related U.S. Application Data
(60) Provisional application No. 63/639,793, filed on Apr. 29, 2024.

(51) Int. Cl. G06F 21/62

(52) U.S. Cl. CPC G06F 21/6218; G06F 21/629

(57) ABSTRACT

Disclosed embodiments may provide techniques for configuring data-access protocols of data objects based on application and computing environment characteristics. A computer-implemented method can include receiving a request to instantiate a computing environment. In some instances, the request identifies a data object to be associated with the computing environment. The computer-implemented method can also include instantiating the computing environment after receiving the request. The computer-implemented method can also include determining that the computing environment is attempting to access the data object to perform one or more computing operations. The computer-implemented method can also include identifying a set of data-access protocols associated with the data object. The computer-implemented method can also include determining that one or more characteristics associated with the computing environment and the one or more computing operations comply with the set of data-access protocols. The computer-implemented method can also include authorizing the computing environment to access the data object.

### CROSS-REFERENCE TO RELATED APPLICATIONS

The present patent application claims the priority benefit of U.S. Provisional Patent Application 63/639,793 filed Apr. 29, 2024, the disclosure of which is incorporated herein by reference.

### FIELD

The present disclosure relates generally to enhancing security of data objects stored in computing environments. In one example, the systems and methods described herein may be used to configuring data-access protocols of data objects based on application or computing environment characteristics.

### SUMMARY

Disclosed embodiments may provide techniques for configuring data-access protocols of data objects based on application and computing environment characteristics. A computer-implemented method can include receiving a request to instantiate a computing environment. In some instances, the request identifies a data object to be associated with the computing environment. The computer-implemented method can also include instantiating the computing environment after receiving the request, in which instantiating the computing environment includes preventing unauthorized access of the data object. The computer-implemented method can also include determining that the computing environment is attempting to access the data object to perform one or more computing operations. The computer-implemented method can also include identifying a set of data-access protocols associated with the data object. The computer-implemented method can also include determining that one or more characteristics associated with the computing environment and the one or more computing operations comply with the set of data-access protocols. The computer-implemented method can also include authorizing the computing environment to access the data object to perform the one or more computing operations.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an example schematic diagram for configuring data-access protocols of data objects based on application characteristics, in accordance with some embodiments.

FIG. 2 shows an example schematic diagram for configuring data-access protocols of data objects based on computing environment characteristics, in accordance with some embodiments.

FIG. 3 shows an illustrative example of a process for configuring data-access protocols of data objects, in accordance with some embodiments.

FIG. 4 illustrates an example schematic diagram for training and deploying a machine-learning model for generating data-access protocols for data objects, according to some embodiments.

FIG. 5 illustrates an example of a transformer in accordance with some embodiments.

FIG. 6 illustrates an example of a scaled dot-product attention in accordance with some embodiments.

FIG. 7 illustrates an example of a multi-head attention sub-layer used in encoder and decoder of transformer, according to some embodiments.

FIG. 8 illustrates an example of a BERT model in accordance with some embodiments.

FIG. 9 shows an example schematic diagram for configuring location-based protocols of data objects, in accordance with some embodiments.

FIG. 10 shows an example schematic diagram for configuring time-based protocols of data objects, in accordance with some embodiments.

FIG. 11 shows an example schematic diagram for configuring operation-type protocols of data objects, in accordance with some embodiments.

FIG. 12 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide techniques for configuring data-access protocols of data objects based on characteristics associated with computing environments. Data-security protocols can configure data objects uploaded within a computing environment, such that they are prevented from being accessed by systems or applications that are outside the computing environment. Preventing access by external systems can ensure that the data object is safe from any security vulnerabilities or cybersecurity threats. In addition, such data-access protocols are usually implemented such that the use of the data object is within compliance of an organization's data security policies or government regulations.

In some instances, certain access to the data objects can be further restricted to applications or systems internal to the computing environments. Existing techniques typically restrict access to the data objects by manually configuring data-access properties on the data object, such as allowing downloads but restricting modifications of a given data object. However, such existing techniques are unable to accommodate for controlling access to a given data object based on time or location-specific situations. It is thus challenging for existing techniques to provide such fine-tuned data access protocols for data objects that are uploaded and stored in computing environments.

To address the above-mentioned deficiencies, the present techniques can provide various data-access protocols that facilitate how data objects can be accessed within computing environments. The data-access protocols of the present techniques can be implemented such that the corresponding data objects can be accessed only within time, location, or use-specific contexts. For example, the present techniques may allow the data object to be accessed for training a machine-learning model, but not for other types of application use (e.g., download, print). Accordingly, the present techniques can be directed to an improvement of data security of data objects stored in computing environments, such that the corresponding data objects can be protected from any intentional or unintentional access by systems within and outside of the computing environments.

### I. Techniques for Controlling Access of Data Objects in Computing Environments

a. Data-Access Protocols Based on Application Characteristics

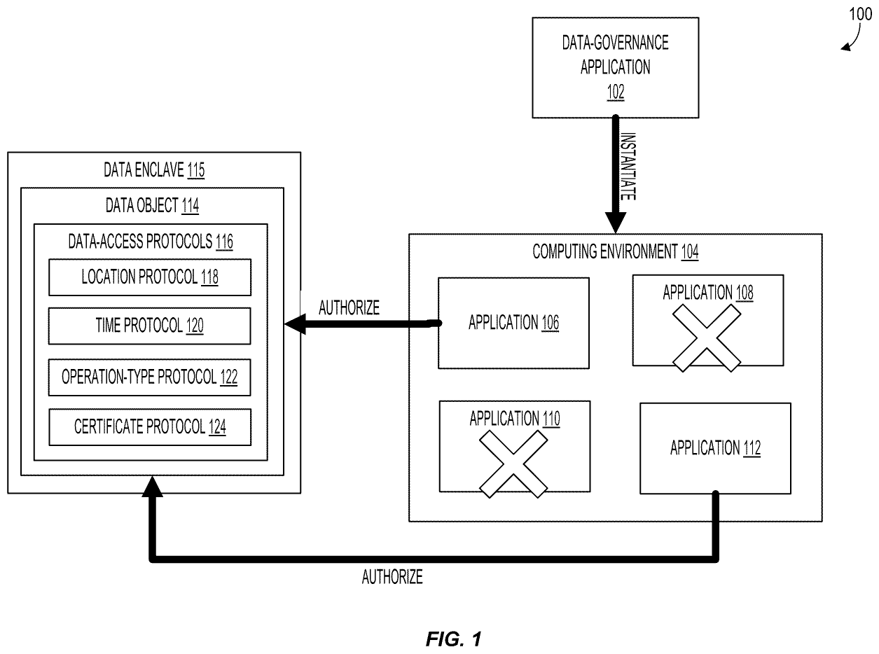

FIG. 1 shows an example schematic diagram 100 for configuring data-access protocols of data objects based on application characteristics, in accordance with some embodiments. As shown in FIG. 1, a data-governance application 102 can be configured to implement data-access protocols of data objects associated with a computing environment 104. In some instances, the data-governance application 102 is a web-based application that can be accessed and used via a web browser over the internet, in which a user device can interact with a server to manage data objects and instantiate one or more computing environments.

The data-governance application 102 can receive a request to instantiate a computing environment 104. The request can include one or more instructions transmitted by the user device over a communication network to instantiate the computing environment 104. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

In some instances, the request identifies a data object 114 to be associated with the computing environment 104. The data object 114 can be configured to store different types of information in computer-readable format, which can be used by various devices and systems to perform various computing operations. For example, the data object 114 can include text data, image data, video data, and/or audio data. In some instances, the data object 114 includes computer-executable code such as a binary file, source code, and/or script data. In another example, the data object 114 can correspond to a training dataset that can be used for training one or more machine-learning models. Other examples of the data object 114 can include, but are not limited to, database records, transaction data, sensor data (e.g., temperature sensors, temperature sensor), user-profile data, geospatial data, configuration settings of one or more applications, and server logs.

The data-governance application 102 can instantiate the computing environment 104 after receiving the request. The computing environment 104 can be a virtualized computing environment (e.g., a hosted virtual machine environment, cloud computing environment, multi-cloud computing environment) that allows multiple virtual machines (VMs) and applications to run concurrently across one or more servers, in which the one or more servers are distributed over a communication network (e.g., the Internet) and managed by one or more computing service providers. Additionally or alternatively, the computing environment 104 can be a physical computing environment (e.g., on-prem computing) configured to run virtual machines (VMs) and applications (e.g., web applications) across one or more servers, in which the one or more servers are located within premises associated with a particular entity. In FIG. 1, the computing environment 104 includes a set of applications 106-112 concurrently running in the computing environment 104. Each of the set of applications 106-112 can perform various types of computing operations, including data processing and analysis, content delivery and media streaming, web application hosting and deployment, and machine-learning classifications. As an illustrative example, the application 106 can be a machine-learning classifier application that performs classification tasks, and the application 110 can be a media-streaming application that provides media content to various user devices.

To instantiate the computing environment 104, the data-governance application 102 can select a particular cloud service provider and generate an account with the provider to obtain access to the provider-specific console or dashboard. The data-governance application 102 can then specify one or more geographic regions for hosting computing resources. The data-governance application 102 can also configure security protocols including identity and access management (IAM) policies, encryption techniques, and network security parameters. The data-governance application 102 can determine resource specifications associated with the computing environment 104 such as virtual machine instances, databases, storage solutions, and networking components. As a result, various characteristics associated with the computing environment 104 can be identified based on the configuration settings used during instantiation.

In some instances, instantiating the computing environment 104 includes preventing unauthorized access of the data object 114. In some instances, the data object 114 is stored in a data enclave 115. The data enclave can be a secure computing environment configured to store and analyze sensitive or restricted data (e.g., the data object 114) while minimizing the risk of unauthorized access or data breaches. For example, the data enclave 115 can implement specialized security measures, access controls, encryption techniques, and data governance policies tailored to protect sensitive data and ensure compliance with relevant regulations and privacy requirements. The data enclave 115 can be an isolated computing environment separate from the computing environment 104. In an alternative embodiment, the computing environment 104 can be configured to integrates security features of the data enclave 115, such that the data object 114 can be stored directly in the computing environment 104. Additional techniques for preventing access of the data object 114 can include implementing firewalls, intrusion-detection systems, data-encryption systems, user-authentication systems, access-control systems, and virtual private networks (VPN). Security policies can also be used to approve or deny permissions by accounts, users or based on different conditions-such as date, IP address or whether the request was over a Secure Sockets Layer (SSL) encrypted session.

The data-governance application 102 can determine that the computing environment 104 is attempting to access the data object 114 to perform one or more computing operations. For example, the data-governance application 102 can include a monitoring component configured to collect metrics and logs from the applications 106-112 and analyze the metrics to identify access attempts on the data object 114. The metrics and logs can additionally identify the applications 106-112 that attempted the access on the data object 114. In some instances, if the data object 114 corresponds to a training dataset, the one or more computing operations can include the application 106 for training a machine-learning model using the training dataset.

The data-governance application 102 can identify a set of data-access protocols 116 associated with the data object 114. The set of data-access protocols 116 can include data-processing rules that are configured to prevent unauthorized access to the data object by other systems and networks. For example, the set of data-access protocols 116 can include permissions and access control settings that prevent unauthorized modifications or downloads of the data object 114. The set of data-access protocols 116 can be implemented using the following techniques: (i) identity and access management (IAM) that define policies that grant or restrict access to files based on criteria such as user identity, IP address, or authentication method; (ii) access control lists (ACLs) that define resource-based policies that govern access to specific resources, including files and storage objects; and (iii) encryption techniques that provide encryption keys and access controls to restrict access to sensitive data and prevent unauthorized disclosure or modification. In some instances, the set of data-access protocols 116 are generated, modified, or deleted any time after the data object 114 is generated. For example, a first data-access protocol can be generated as the data object 114, a second data-access protocol can be generated 10 days after the data object 114 was generated, and the first data-access protocol can be modified 15 days after the data object 114 was generated. The modifications or deletions of the set of data-access protocols can dynamically update the access permissions of the data object 114 by the applications 106-112 running on the computing environment 104.

In some instances, the set of data-access protocols 116 is associated with one or more types. For example, the set of data-access protocols 116 can include a location-based protocol 118, in which the location-based protocol 118 can specify a set of regions for which the data object 114 is authorized to be accessed. The set of regions can indicate IP addresses, zip codes, street addresses, geolocation data, and countries at which the data object 114 can be accessed. In some instances, the location-based protocol 118 indicates that the computing environment 104 needs to be instantiated within one of the set of regions to obtain access to the data object 114. Additionally or alternatively, the location-based protocol 118 can indicate that the user device that transmitted the request needs to be located within one of the set of regions to obtain access to the data object 114. The location-based protocol 118 can also indicate that the data object 114 needs to be stored within one of the set of regions to obtain access by the computing environment 104.

In another example, the set of data-access protocols 116 can include a time-based protocol 120, in which the time-based protocol 120 can specify a time period during which the data object is authorized to be accessed. For example, the time-based protocol 120 can indicate that the data object 114 can be accessed only by applications that were launched in the computing environment 104 after a particular time period. In another example, the time-based protocol 120 can indicate that the data object 114 can be accessed only by applications that are associated within a computing environment that was instantiated within a particular time window.

In yet another example, the set of data-access protocols 116 can include an operation-type protocol 122, in which the operation-type protocol 122 specifies types of computing operations for which the data object 114 is authorized to be accessed. For example, the operation-type protocol 122 can indicate that the data object 114 can be accessed for data analysis and training of machine-learning models, but not facilitating download of the data object 114 to other devices accessing the computing environment 104. The set of data-access protocols 116 can additionally include a certificate protocol 124, in which the certificate protocol 124 identifies one or more applications that were previously authorized to access the data object 114.

In some instances, to identify the set of data-access protocols 116, the data-governance application 102 applies a machine-learning model to the data object (and corresponding metadata or description) to generate an output that identifies the set of data-access protocols 116. To apply the machine-learning model, a machine-learning model selected from a model database can be trained using a training dataset. The training dataset can include a plurality of data-access protocols determined for previous data objects stored in one or more computing environments. The training of the machine-learning model can be performed until a corresponding loss (e.g., a mean square error) reaches a minimum threshold. The trained machine-learning model can then be provided to the data-governance application 102, which can apply the trained machine-learning model to the data object (and corresponding metadata or description) to identify the set of data-access protocols 116.

The machine-learning model may be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. Techniques for using machine-learning models to determine the set of protocols are further described in Section II of the present disclosure.

The data-governance application 102 can determine that one or more characteristics associated with the computing environment 104 and the one or more computing operations comply with the set of data-access protocols. For example, the data-governance application 102 can identify the characteristics by extracting metadata associated with the computing environment 104. Examples of the metadata can include: (i) current application version of the computing environment 104; (ii) the date and location at which the environment was instantiated; (iii) applications running in the computing environment 104; (iv) types of computing operations performed by the applications running the in the computing environment 104; (v) an indication whether a particular application is certified by an administrator of the computing environment 104; and (vi) one or more geographic regions at which the computing environment 104 was instantiated.

As an illustrative example, the one or more characteristics can identify various aspects associated with the applications 106-112 that were launched in the computing environment 104. In another example, the one or more characteristics can further identify, for each of the applications 106-112: (i) a version associated with the application; (ii) time at which the application was launched; and (iii) types of computing operations that can be performed by the application.

The characteristics can be determined to comply with the data-access protocols 116 based on the corresponding types of the data-access protocols 116. For example, the one or more characteristics can indicate that the computing environment 104 was instantiated at one of the set of geographic regions specified by the location-based protocol 118. In another example, the one or more characteristics can indicate that the computing environment 104 was instantiated within the time period specified by the time-based protocol 120. In yet another example, the one or more characteristics can indicate that the one or more computing operations correspond at least one of the types of computing operations specified by the operation-type protocol 122. Based on such determination, the data-governance application 102 can determine whether the computing environment 104 and/or the applications 106-112 can access the data object 114.

In some instances, by using the set of data-access protocols 116, the data-governance application 102 prevents the data object 114 from unauthorized access (e.g., application that violates one of the set of data protocols 116). For example, the data-governance application 102 can determine that the computing environment 104 is attempting to access the data object 114 to perform a different set of computing operations that are outside the scope of the data-access protocols 116. If the data-governance application 102 determines that one or more characteristics associated with the different set of computing operations violates the operation-type protocol 122, the data-governance application 102 can deny access of the data object to the different set of computing operations.

Referring to the examples shown in FIG. 1, the data-governance application 102 can determine that one or more characteristics associated with the applications 106 and 112 comply with the set of data-access protocols 116. For example, the applications 106 and 112 were launched in the computing environment 104 that satisfies the location-based protocol 118 and time-based protocol 120. In addition, the applications 106 and 112 may be associated with certain characteristics (e.g., type of computing operation, version of the application) that satisfy remaining data-access protocols. In contrast, the data-governance application 102 can also determine that one or more characteristics associated with the applications 108 and 110 violate one or more of the set of data-access protocols 116. For example, the applications 106 and 112 may include code that have been identified to have security vulnerabilities and thus violate one or more data-access protocols.

After determining that the characteristics comply with the data-access protocols 116, the data-governance application 102 can authorize the applications 106 and 112 to access the data object 114 to perform the one or more computing operations. Continuing with the examples shown in FIG. 1, the data-governance application 102 can grant access to the applications 106 and 112 in the computing environment 104, while simultaneously denying access to the applications 108 and 110. In some instances, to prevent the data objects from future unauthorized access, the data-governance application deletes the data object after completion of the one or more computing operations.

### B. Data-Access Protocols Based on Computing Environment Characteristics

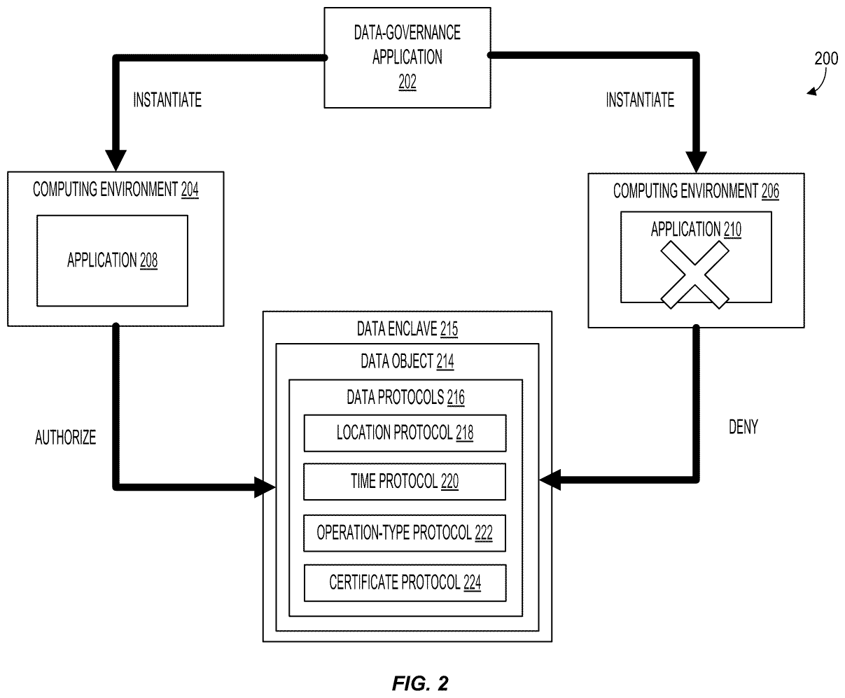

FIG. 2 shows an example schematic diagram 200 for configuring data-access protocols of data objects based on computing environment characteristics, in accordance with some embodiments. As shown in FIG. 2, a data-governance application 202 can be configured to implement data-access protocols of data objects associated with multiple computing environments. In some instances, the data-governance application 202 is a web-based application that can be accessed and used via a web browser over the internet, in which the user device can interact with a server to manage data objects and instantiate one or more computing environments.

The data-governance application 202 can receive a request to instantiate computing environments 204 and 206. The request can include one or more instructions transmitted by the user device over a communication network to instantiate the computing environments 204 and 206. As described in FIG. 1, the network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network can be wired connections, wireless connections, or combinations thereof.

In some instances, the request identifies a data object 214 to be associated with the computing environments 204 and 206. The data object 214 can be configured to store different types of information in computer-readable format, which can be used by various devices and systems to perform various computing operations. For example, the data object 214 can include text data, image data, video data, and/or audio data. In some instances, the data object 214 includes computer-executable code such as a binary file, source code, and/or script data. In another example, the data object 214 can correspond to a training dataset that can be used for training one or more machine-learning models. Other examples of the data object 214 can include, but are not limited to, database records, transaction data, sensor data (e.g., temperature sensors, temperature sensor), user-profile data, geospatial data, configuration settings of one or more applications, and server logs.

The data-governance application 202 can instantiate the computing environments 204 and 206 after receiving the request. As described herein, at least one of the computing environments 204 and 206 can be a virtualized computing environment (e.g., a hosted virtual machine environment, cloud computing environment, multi-cloud computing environment) that allows multiple virtual machines (VMs) and applications to run concurrently across one or more servers, in which the one or more servers are distributed over a communication network (e.g., the Internet) and managed by one or more computing service providers. Additionally or alternatively, the computing environment 204 or 206 can be a physical computing environment (e.g., on-prem computing) configured to run virtual machines (VMs) and applications (e.g., web applications) across one or more servers, in which the one or more servers are located within premises associated with a particular entity. In FIG. 2, the computing environment 204 includes an application 208 running in the computing environment 204, and the computing environment 206 includes an application 210 running in the computing environment 206. Each of the applications 208-1010 can perform various types of computing operations, including data processing and analysis, content delivery and media streaming, web application hosting and deployment, and machine-learning classifications. As an illustrative example, the application 208 can be a machine-learning classifier application that performs classification tasks, and the application 210 can be a network-traffic analysis application that collects network statistics from devices accessing the computing environment 206.

To instantiate each of the computing environments 204 and 206, the data-governance application 202 can select a particular cloud service provider and generate an account with the provider to obtain access to the provider-specific console or dashboard. The data-governance application 202 can then specify one or more geographic regions for hosting computing resources. The data-governance application 202 can also configure security protocols including IAM policies, encryption techniques, and network security parameters. The data-governance application 202 can determine resource specifications associated with the computing environments such as virtual machine instances, databases, storage solutions, and networking components. As a result, various characteristics associated with the computing environments 204 and 206 can be identified based on the configuration settings used during instantiation.

In some instances, instantiating the computing environment 204 includes preventing unauthorized access of the data object 214. In some instances, the data object 214 is stored in a data enclave 215. The data enclave 215 can be a secure computing environment configured to store and analyze sensitive or restricted data (e.g., the data object 214) while minimizing the risk of unauthorized access or data breaches. In some instances, the data enclave 215 is an isolated computing environment separate from the computing environments 204 and 206. In an alternative embodiment, the computing environment 204 and/or 206 can be configured to integrates security features of the data enclave 215, such that the data object 214 can be stored directly in the respective computing environments. As described above, additional techniques for preventing access of the data object 214 can include implementing firewalls, intrusion-detection systems, data-encryption systems, user-authentication systems, access-control systems, and virtual private networks (VPN). Security policies can also be used to approve or deny permissions by accounts, users or based on different conditions-such as date, IP address or whether the request was over a Secure Sockets Layer (SSL) encrypted session.

The data-governance application 202 can determine that the computing environments 204 and 206 are attempting to access the data object 214 to perform their respective computing operations. For example, the data-governance application 202 can include a monitoring component configured to collect metrics and logs from the computing environments 204 and 206 and analyze the metrics to identify access attempts on the data object 214. The metrics and logs can additionally identify the applications that attempted the access on the data object 214. In some instances, if the data object 214 corresponds to a training dataset, the one or more computing operations can include the application 208 for training a machine-learning model using the training dataset.

The data-governance application 202 can identify a set of data-access protocols 216 associated with the data object 214. As described herein, the set of data-access protocols 216 can include data-processing rules that are configured to prevent unauthorized access and modifications to the data object 214 by other systems and networks. The set of data-access protocols 216 can be implemented using the following techniques: (i) identity and access management (IAM) that define policies that grant or restrict access to files based on criteria such as user identity, IP address, or authentication method; (ii) access control lists (ACLs) that define resource-based policies that govern access to specific resources, including files and storage objects; and (iii) encryption techniques that provide encryption keys and access controls to restrict access to sensitive data and prevent unauthorized disclosure or modification. In some instances, the set of data-access protocols 216 are generated, modified, or deleted any time after the data object 214 is generated. The modifications or deletions of the set of data-access protocols can dynamically update the access permissions of the data object 214 by the applications running on the computing environments 204 and 206.

In some instances, the set of data-access protocols 216 is associated with one or more types. For example, the set of data-access protocols 216 can include a location-based protocol 218, in which the location-based protocol 218 can specify a set of regions for which the data object 214 is authorized to be accessed. In another example, the set of data-access protocols 216 can include a time-based protocol 220, in which the time-based protocol 220 can specify a time period during which the data object is authorized to be accessed. In yet another example, the set of data-access protocols 216 can include an operation-type protocol 222, in which the operation-type protocol 222 specifies types of computing operations for which the data object 214 is authorized to be accessed. The set of data-access protocols 216 can additionally include a certificate protocol 224, in which the certificate protocol 224 identifies one or more applications that were previously authorized to access the data object 214. Examples relating to various types of data-access protocols are further described in Section I.A of the present disclosure.

In some instances, to identify the set of data-access protocols 216, the data-governance application 202 applies a machine-learning model to the data object (and corresponding metadata or description) to generate an output that identifies the set of data-access protocols 216. To apply the machine-learning model, a machine-learning model selected from a model database can be trained using a training dataset. The training dataset can include a plurality of data-access protocols determined for previous data objects stored in one or more computing environments. The training of the machine-learning model can be performed until a corresponding loss (e.g., a mean square error) reaches a minimum threshold. The trained machine-learning model can then be provided to the data-governance application 202, which can apply the trained machine-learning model to the data object (and corresponding metadata or description) to identify the set of data-access protocols 216.

The machine-learning model may be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. Techniques for using machine-learning models to determine the set of protocols are further described in Section II of the present disclosure.

The data-governance application 202 can determine that one or more characteristics associated with the computing environment 204 comply with the set of data-access protocols 216. By contrast, the data-governance application 202 can determine that characteristics associated with the computing environment 206 violate the set of data access protocols 216. For example, the data-governance application 202 can identify the characteristics by extracting metadata associated with each of the computing environment 204 and the computing environment 206. Examples of the metadata can include: (i) current application version of the computing environment; (ii) the date and location at which the environment was instantiated; (iii) applications running in the computing environment; (iv) types of computing operations performed by the applications running the in the computing environment; (v) an indication whether a particular application is certified by an administrator of the computing environment; and (vi) one or more geographic regions at which the computing environment was instantiated. In some instances, the data-governance application 202 determines that the characteristics comply with the data-access protocols 216 based on the corresponding types of the data-access protocols 216 (e.g., location-based protocols 218, time-based protocols 220).

Referring to the examples shown in FIG. 2, the data-governance application 202 can determine that one or more characteristics associated with the computing environment 204 comply with the set of data-access protocols 216. For example, the computing environment 204 was instantiated: (i) at a geographic region that satisfies the location-based protocol 218; and (ii) at a time period that satisfies the conditions associated with the time-based protocol 220. In contrast, the data-governance application 202 can also determine that one or more characteristics associated with the computing environment 206 violate one or more protocols of the set of data-access protocols 216. For example, the computing environment 206 was instantiated at a geographic region that violates the location-based protocol 218. In another example, the computing environment 206 included the application 210 that executes computing operations that that violate the operation-type protocol 222.

After determining that the characteristics comply with the data-access protocols 216, the data-governance application 202 can authorize the application 208 of the computing environment 204 to access the data object 214. Continuing with the examples shown in FIG. 2, the data-governance application 202 can grant access to the application 208 in the computing environment 204, while simultaneously denying access to the application 210 in the computing environment 206. In some instances, to prevent the data objects from future unauthorized access, the data-governance application deletes the data object 214 after completion of the one or more computing operations.

### C. Methods

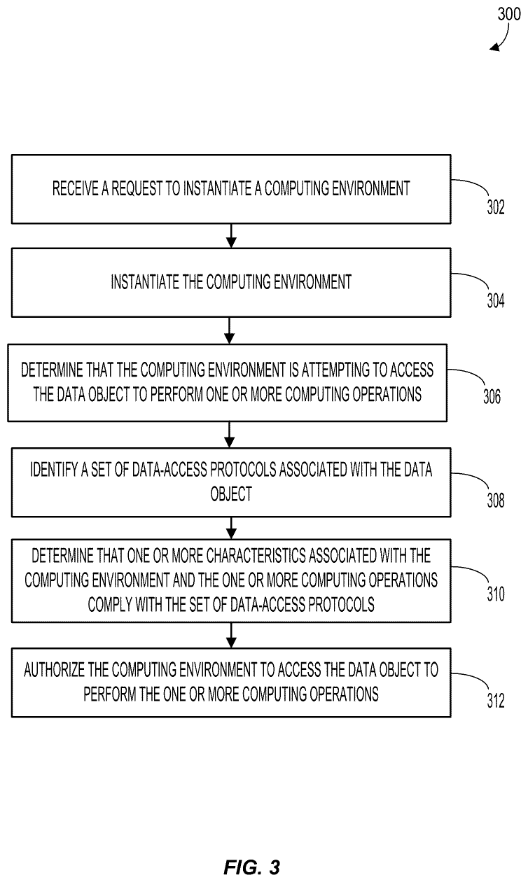

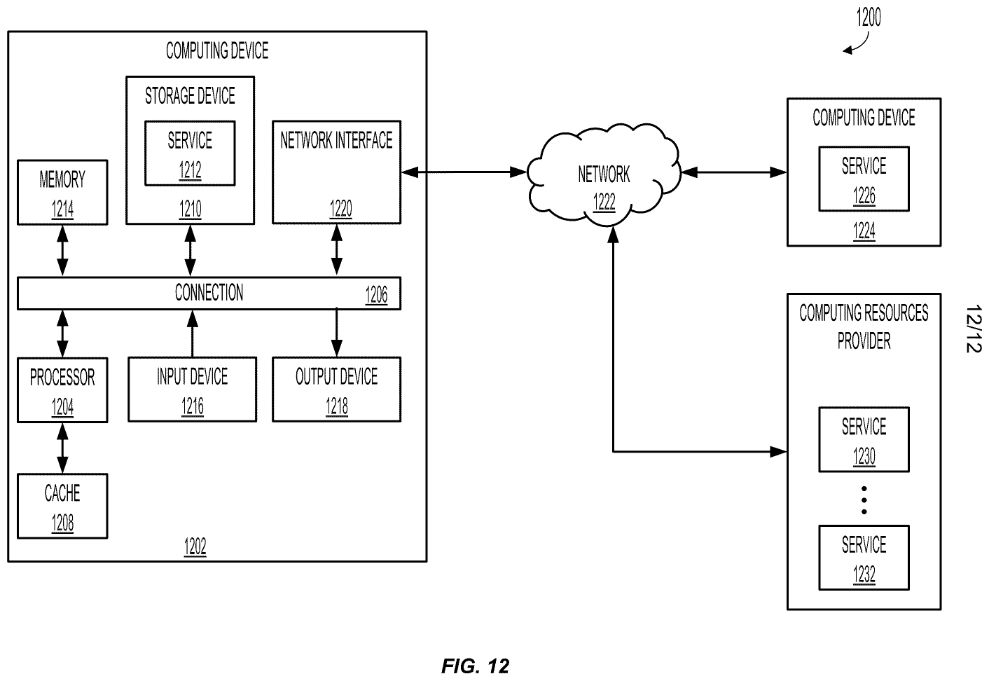

FIG. 3 shows an illustrative example of a process 300 for configuring data-access protocols of data objects, in accordance with some embodiments. For illustrative purposes, the process 300 is described with reference to the components illustrated in FIGS. 1-10, though other implementations are possible. For example, the program code for the data-governance application 102 of FIG. 1, is executed by one or more processing devices to cause a server system (e.g., the computing device 1202 of FIG. 12) to perform one or more operations described herein.

At step 302, the data-governance application can receive a request to instantiate a computing environment. In some instances, the request identifies a data object to be associated with the computing environment. The data object can be configured to store different types of information in computer-readable format, which can be used to perform various computing operations. For example, the data object can include text data, image data, video data, and/or audio data. In some instances, the data object includes computer-executable code such as a binary file, source code, and/or script file. In another example, the data object can correspond to a training dataset that can be used for training one or more machine-learning models.

At step 304, the data-governance application can instantiate the computing environment after receiving the request. In some instances, instantiating the computing environment includes preventing unauthorized access of the data object. Preventing access of the data object can include implementing firewalls, intrusion-detection systems, data-encryption systems, user-authentication systems, access-control systems, and virtual private networks (VPN). As an illustrative example, the computing environment can be configured to include identity and access management (IAM) policies and access control lists (ACLs) that centralize the control of permissions to storage. Security policies can also be used to approve or deny permissions by accounts, users or based on different conditions-such as date, IP address or whether the request was over a Secure Sockets Layer (SSL) encrypted session.

At step 306, the data-governance application can determine that the computing environment is attempting to access the data object to perform one or more computing operations. For example, the data-governance application can include a monitoring component configured to collect metrics and logs from the computing environment and analyze the metrics to identify access attempts on the data object. The metrics and logs can additionally identify applications in the computing environment that attempted the access on the data object. In some instances, if the data object corresponds to a training dataset, the one or more computing operations can include training a machine-learning model using the training dataset.

At step 308, the data-governance application can identify a set of data-access protocols associated with the data object. The set of data-access protocols can include data-processing rules that are configured to prevent unauthorized access to the data object by other systems and networks. For example, the set of data-access protocols can prevent unauthorized modifications or downloads of the data object. In some instances, the set of data-access protocols is associated with one or more types. As an illustrative example, the set of data-access protocols can include a location-based protocol, in which the location-based protocol can specify a set of regions for which the data object is authorized to be accessed. In another example, the set of data-access protocols can include a time-based protocol, in which the time-based protocol can specify a time period during which the data object is authorized to be accessed. In yet another example, the set of data-access protocols can include an operation-type protocol, in which the operation-type protocol specifies types of computing operations for which the data object is authorized to be accessed.

At step 310, the data-governance application can determine that one or more characteristics associated with the computing environment and the one or more computing operations comply with the set of data-access protocols. For example, the data-governance application can identify the characteristics by extracting metadata associated with the computing environment. Examples of the metadata can include: (i) current application version of the environment; (ii) the date and location at which the environment was instantiated; (iii) applications running in the computing environment; (iv) types of computing operations performed by the applications running the in the computing environment; and (v) an indication whether a particular application is certified by an administrator of the computing environment.

The characteristics can be determined to comply with the data-access protocols based on the corresponding types of the data-access protocols. For example, the one or more characteristics can indicate that the computing environment was instantiated at one of the set of regions specified by the location-based protocol. In another example, the one or more characteristics can indicate that the computing environment was instantiated within the time period specified by the time-based protocol. In yet another example, the one or more characteristics can indicate that the one or more computing operations correspond at least one of the types of computing operations specified by the operation-type protocol. Based on such determination, the data-governance application can determine whether the computing environment can access the data object.

In some instances, by using the set of data-access protocols, the data-governance application prevents the data object from being accessed by unauthorized applications associated with the computing environment. For example, the data-governance application can determine that the computing environment is attempting to access the data object to perform a different set of computing operations. If the data-governance application determines that one or more characteristics associated with the different set of computing operations violates the set of data-access protocols, the data-governance application can deny access of the data object to the other executable code.

At step 312, the data-governance application can authorize the computing environment to access the data object to perform the one or more computing operations. In some instances, to prevent the data objects from future unauthorized access, the data-governance application deletes the data object after completion of the one or more computing operations. Process 300 terminates thereafter.

### II. Machine-Learning Techniques for Configuring Data-Access Protocols of Data Objects

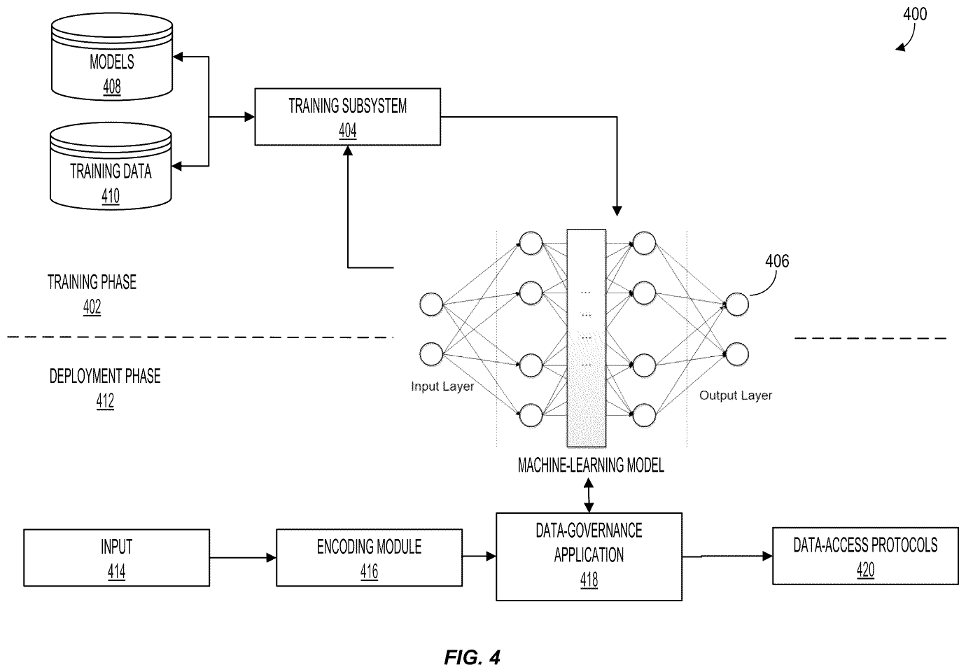

FIG. 4 illustrates an example schematic diagram 400 for training and deploying a machine-learning model for generating data-access protocols for data objects, according to some embodiments. As shown in FIG. 4, machine-learning techniques for generating data-access protocols for data objects can be initiated by a training subsystem 404 accessing an initial machine-learning model 406 from a models database 408 (e.g., a training phase 402). As an illustrative example, the machine-learning model 406 can be a transformer model selected from the models database 408, which is described further below.

### A. Model Selection

### 1. BERT Architecture

A BERT model uses Masked Language Modeling (MLM), a self-supervised pre-training objective that allows a transformer encoder to encode a sequence from both directions simultaneously. Specifically, for an input sequence S=(w₁, . . . , w_{N}) of N tokens, BERT first randomly masks out 15% of the tokens and then predicts the masked tokens in the output. The masked tokens in the input sequence are represented by a special symbol [MASK] and fed into a multi-layer transformer encoder. For example, let H^{l}=(h₁, . . . , h_{N}) be the encoded features at the 1-th transformer layer, with 11° being the input layer. The features at the (l+1)-th layer are obtained by applying a transformer block defined as:

$${H}^{l + 1} = L N ( L N ( {H}^{l} + {f}_{Self - Att}^{l} ( {H}^{l} ) ) + {f}_{F F}^{l} ( L N ( {H}^{l} ( {H}^{l} + {f}_{Self - Att}^{l} ( {H}^{l} ) ) ) )$$

where LN stands for layer normalization, f_{self-Att}^{l}(⋅) is a multi-headed self-attention sub-layer, f_{FF}(⋅) is a feed-forward sub-layer composed of two fully-connected (FC) layers, wrapped in residual connection with an LN. The token representations in the final layer are used to predict the masked tokens independently.

### 2. BERT Implementation

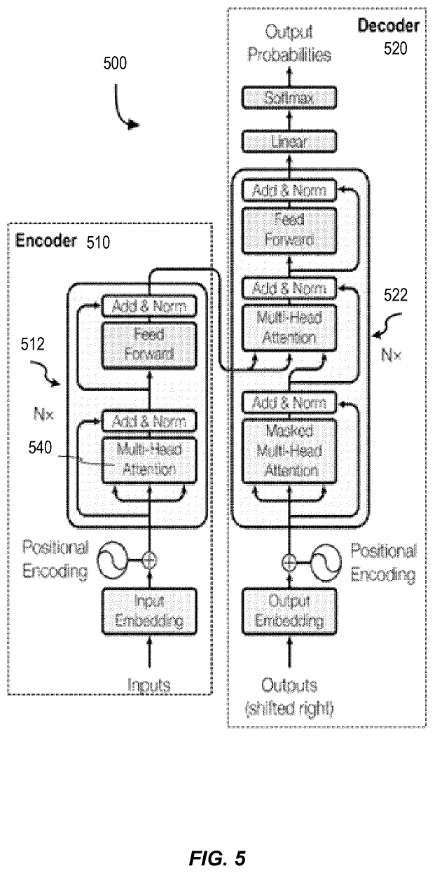

FIG. 5 illustrates an example of a transformer 500 in accordance with some embodiments. Transformer 500 may include an encoder 510 and a decoder 520. Encoder 510 may include a stack of N layers 512. Each layer 512 may include two sub-layers that perform matrix multiplications and element-wise transformations. The first sub-layer may include a multi-head self-attention network, and the second sub-layer may include a position-wise fully connected feed-forward network. A residual connection may be used around each of the two sub-layers, followed by layer normalization. A residual connection adds the input to the output of the sub-layer, and is a way of making training deep networks easier. Layer normalization is a normalization method in deep learning that is similar to batch normalization. The output of each sub-layer may be written as LN(x+Sublayer(x)), where Sublayer(x) is the function implemented by the sub-layer. In the encoder phase, the Transformer first generates initial inputs (e.g., input embedding and position encoding) for each word in the input sentence. For each word, the self-attention aggregates information from all other words (pairwise) in the context of the sentence to create a new representation for each word that is an attended representation of all other words in the sequence. This is repeated for multiple times each word in a sentence to successively build newer representations on top of previous ones.

Decoder 520 may also include a stack of N layers 522. In addition to the two sub-layers in each encoder layer 512 described above, each layer 522 in decoder 520 may include a third sub-layer that performs multi-head attention over the output of the encoder stack. Similar to layers 512 in encoder 510, residual connections around each of the sub-layers may be used in layers 522 in decoder 520, followed by layer normalization. The self-attention sub-layer in the decoder stack may be modified (labeled as “masked multi-head attention”) to mask inputs to the decoder from future time steps and prevent positions from attending to subsequent positions. The masking, combined with offsetting the output embeddings by one position, ensures that the predictions for position i can depend only on the known outputs at positions less than i. Decoder 520 may generate one word at a time from left to right. The first word generated at a layer may be based on the final representation of the encoder (offset by 1 position). Every word predicted subsequently may attend to the previously generated words at that layer of the decoder and the final representation of the encoder.

An attention function may map a query and a set of key-value pairs to an output, where the query, keys, values, and output are all vectors. A query vector q encodes the word/position that is paying attention. A key vector k encodes the word to which attention is being paid. The key vector k and the query vector q together determine the attention score between the respective words. The output is computed as a weighted sum of values, where the weight assigned to each value is computed by a compatibility function of the query with the corresponding key.

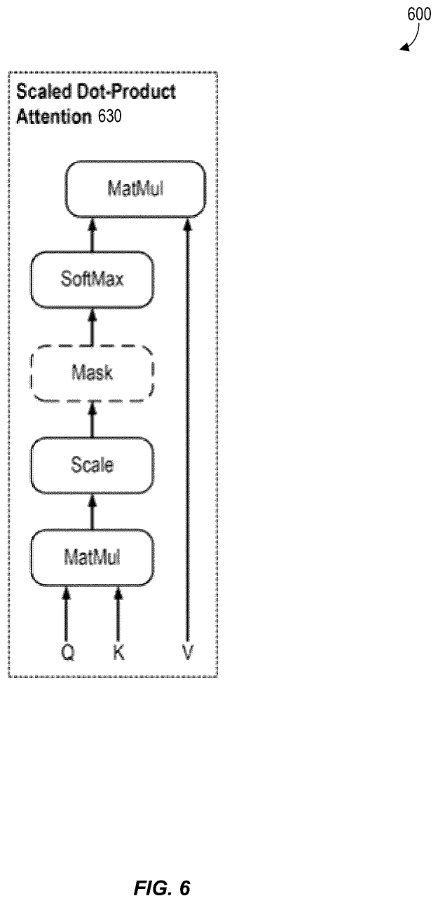

FIG. 6 illustrates an example of a scaled dot-product attention 630 in accordance with some embodiments. The scaled dot-product attention 630 is one of the attention mechanisms that can be used by an encoding layer 512 of the transformer 500. In scaled dot-product attention block 630, the input includes queries and keys both of dimension dₖ, and values of dimension dᵥ. The scaled dot-product attention may be computed on a set of queries simultaneously, according to the following equation:

$$Attention ( Q , K , V ) = softmax ( \frac{Q {K}^{T}}{\sqrt{{d}_{k}}} ) V ,$$

where Q is the matrix of queries packed together, and K and V are the matrices of keys and values packed together. The scaled dot-product attention computes the dot-products (attention scores) of the queries with all keys (“MatMul”), divides each element of the dot-products by a scaling factor \sqrt{dₖ} (“scale”), applies a softmax function to obtain the weights for the values, and then uses the weights to determine a weighted sum of the values.

When only a single scaled dot-product attention 630 is used to calculate the weighted sum of the values, it can be difficult to capture various different aspects of the input. For instance, in the sentence “I like cats more than dogs,” one may want to capture the fact that the sentence compares two entities, while retaining the actual entities being compared. To address this issue, the transformer 500 uses the multi-head self-attention sub-layer to allow the encoder and decoder to see the entire input sequence all at once. To learn diverse representations, the multi-head attention applies different linear transformations to the values, keys, and queries for each attention head, where different weight matrices may be used for the multiple attention heads and the results of the multiple attention heads may be concatenated together.

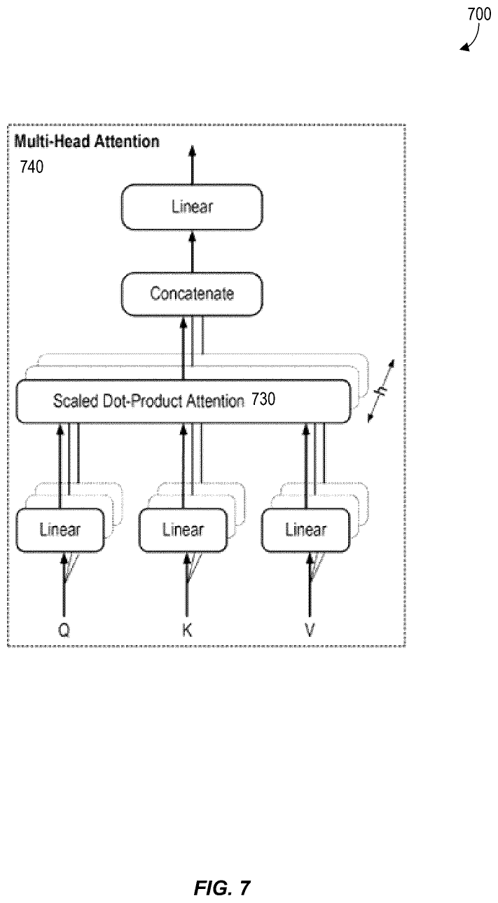

FIG. 7 illustrates an example of a multi-head attention sub-layer 740 used in encoder 710 and decoder 720 of transformer 700 described above. The multi-head attention sub-layer 740 includes a multi-head mechanism in which several scaled dot-product attentions 730 (e.g., the scaled dot-product attention 630 of FIG. 6) process input data in parallel. Instead of performing a single attention function with d_{model}-dimensional keys, values, and queries, multi-head self-attention sub-layer 740 linearly projects the queries, keys, and values multiple (e.g., h) times with different, learned linear projections to dₖ, dₖ, and dᵥ, respectively. Attention functions are performed in parallel on the h projected versions of queries, keys, and values using multiple (e.g., h) scaled dot-product attentions, yielding (h×dᵥ)-dimensional output values. Each attention head may have a structure as shown in FIG. 6, and may be characterized by three different projections given by weight matrices:

$${W}_{i}^{K} with dimensions {d}_{m o d e l} \times {d}_{k}$$

$${W}_{i}^{Q} with dimensions {d}_{m o d e l} \times {d}_{k}$$

$${W}_{i}^{V} with dimensions {d}_{m o d e l} \times {d}_{v}$$

The outputs of the multiple scaled dot-product attentions are concatenated, resulting in a matrix of dimensions dᵢ×(h×dᵥ), where dᵢ is the length of the input sequence. Afterwards, a linear layer with weight matrix W^{o} of dimensions (h×dᵥ)×dₑ is applied to the concatenation result, leading to a final result of dimensions dᵢ×dₑ:

$$MultiHead ( Q , K , V ) = Concat ( {head}_{1} , … , {head}_{h} ) {W}^{o}$$

$$where {head}_{i} = Attention ( {QW}_{i}^{Q} , {KW}_{i}^{K} , {VQ}_{i}^{V} )$$

where dₑ is the dimension of the token embedding. Multi-head attention allows a network to jointly attend to information from different representation subspaces at different positions. The multi-head attention may be performed using a tensor operation, which may be split into multiple sub-operations (e.g., one for each head) and performed in parallel by multiple computing engines as described above.

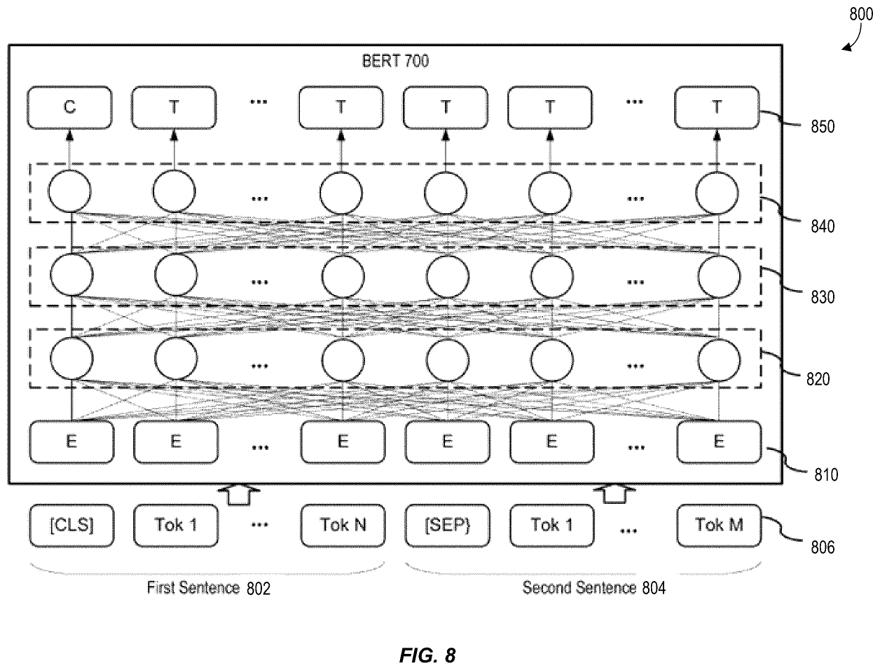

FIG. 8 illustrates an example of a BERT model 800 in accordance with some embodiments. A BERT model may include a multi-layer bidirectional Transformer encoder (rather than a left-to-right Transformer encoder), and does not include the Transformer decoder because the BERT model is used to generate a language model. The BERT model is designed to pre-train deep bidirectional representations from unlabeled text by jointly conditioning on both the left and right context in all layers. The pre-trained BERT model can be fine-tuned with an additional output layer to create state-of-the-art models for a wide range of tasks, such as question answering and language inference, without substantial task-specific architecture modifications. BERT alleviates the unidirectionality protocol by using a MLM pre-training objective. The masked language model randomly masks some of the tokens from the input, and the objective is to predict the original vocabulary identification (Id) of the masked word based only on its context. Unlike the left-to-right language model pre-training, the MLM objective enables the representation to fuse the left and the right context, which allows pre-training a deep bidirectional Transformer. In addition to the masked language model, a “next sentence prediction” task can be used to jointly pre-train text-pair representations.

In the example shown in FIG. 8, the BERT model 800 uses inputs that include a sequence of tokens 806, which may include one or more sentences, such as first sentence 802 and second sentence 804. In some embodiments, some (e.g., about 15% of) tokens 806 may be masked. Input tokens 806 may be embedded into vectors 810 and processed by encoder layers 820, 830, and 840 to generate a sequence of tokens 850 each represented by a vector. Encoder layers 820, 830, . . . , and 840 may form a multi-layer perceptron. Each encoder layer 820, 830, . . . , or 840 may be similar to encoder layers 512 and may include the multi-head attention model and/or fully connected layer. The multi-head attention model may include multiple dot-product attentions. Operations of each encoder layer 820, 830, or 840 may include a tensor operation that can be split into sub-operations that have no data dependency between each other and thus can be performed by multiple computing engines (e.g., accelerators) in parallel as described above.

In addition to the BERT model, other types of the content machine-learning model can be selected, including Claude LLM, Falcon 50B, Ernie, GPT-3, GPT-3.5, GPT 5, Lamda, and Llama. For example, the content machine-learning model can be a GPT-4 model which can include trillions of parameters that can process both language and images to generate the customized content.

### B. Training

Referring back to FIG. 4, once the machine-learning model 406 is selected, the training subsystem 404 can train the machine-learning model 406 using a training dataset accessed from a training database 410. Various training and test data sets may be utilized to train the machine-learning model such that once trained, the machine-learning model 406 can generate the data-access protocols (e.g., the data-access protocols 116 of FIG. 1) based the characteristics associated with the data object (e.g., metadata of data object, type of data object, text description associated with the data object). Examples characteristics of the data object can include configuration settings determined for the data object (e.g., read-only access levels, identity of user that uploaded the data object, the time the data object was uploaded) as the data object was uploaded and stored in the computing environment. Other example characteristics can include, but are not limited to, the following:
1. File Name: The name of the data object, which typically provides information about its content or purpose.
2. File Size: The size of the data object in bytes, kilobytes, megabytes, etc., indicating the amount of storage space it occupies.
3. File Format/Extension: The format or extension of the data object, such as .csv, .txt, .json, .xls, etc., indicating the structure and type of data it contains.
4. Creation Date/Time: The date and time when the data object was created or generated.
5. Last Modified Date/Time: The date and time when the data object was last modified or updated.
6. Owner: The identity of the user or entity that created or owns the data object.
7. Permissions: The access permissions granted to users or groups regarding reading, writing, or executing the data object.
8. File Location/Path: The directory or path where the data object is stored within the file system.
9. Data Source: Information about the source or origin of the data contained within the file, such as database, sensor, web scraping, etc.
10. Data Description/Metadata: Descriptive information about the contents of the data object, including column names, data types, units, and any other relevant metadata.

In some instances, the training dataset can include labeled training data, in which the training or “ground-truth” labels correspond to data-access protocols determined for previous data objects stored in one or more computing environments.

A large pool of data accessed from the training database 410 may be split into two classes of data called training data set and test data set. For example, 70% of the accessed data from the pool may be used as part of the training data set while the remaining 30% of the accessed data from the pool may be used as part of the test data set. The percentages according to which the pool of the data are split into training data set and test data set is not limited to 70/30 and may be set according to a configurable accuracy requirement and/or error tolerance (e.g., the split can be 50/50, 60/40, 70/30, 80/20, 90/10, etc. between the two data sets).

The training subsystem can then use the training dataset to train the machine-learning model 406 by calculating a loss based on a comparison between an actual output generated from the machine-learning model and an expected output of the content machine-learning model. With each output generated by the machine-learning model 406, the expected output can thus be used to correct the actual output of the machine-learning model 406. In some instances, manual feedback is further utilized to adjust the corresponding parameters of the machine-learning model. As noted, weights of different nodes of the machine-learning model 406 may be adjusted/tuned during the training process to improve resulting output.

During training, weights of nodes associated with the machine-learning model 406 can be adjusted using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned. In particular, the training of the machine-learning model 406 (e.g., adjustment of the weights) can be performed until a corresponding loss (e.g., a mean square error) reaches a minimum threshold.

Once trained, the training subsystem 404 can test the machine-learning model 406 using the test data set. Examples of testing methods can include regression testing, unit testing, beta testing, and alpha testing. In some instances, the machine-learning model 406 can be fine-tuned with an additional output layer to create state-of-the-art models for a wide range of tasks, such as question answering and language inference, without substantial task-specific architecture modifications.

Once the result of testing the machine-learning model 406 is satisfactory (e.g., when outputs of the testing stage is greater than or equal to a threshold or incorrect detections are less than a threshold), the training subsystem 404 can deploy the trained machine-learning model 406 (which may also be referred to as a trained machine learning model or machine trained neural network) to a data-governance application 418, which can use the trained machine-learning model 406 to generate data-access protocols based on various characteristics associated with the data-access protocol.

### C. Deployment

After accessing the trained machine-learning model 406, the content-generation can proceed with a deployment phase 412, in which the data-governance application 418 applies the trained machine-learning model 406 to input 414 to generate data-access protocols 420. The input 414 can include a data object. In some instances, text description associated with the data object can be provided via a user-provided input. Example text description can include instructions, questions, or any other types of text input that relate to the data object. The data object can be preprocessed to identify its various characteristics, including file name, file size, file format, creation date, last modified date, owner, permissions, file path, and data source

In some instances, an encoding module 416 can encode the input 414 to generate a feature vector. The feature vector can include a set of values (e.g., a numerical array) that represent the input data, in which the feature vector can be used as input to the machine-learning model 406. Example techniques for generating feature vectors can include one-hot encoding techniques, sequence-embedding techniques, and other tokenization techniques.

The data-governance application 418 can then apply the trained machine-learning model 406 (e.g., the neural network, the BERT model) to the feature vector to generate the data-access protocols 420. The data-access protocols 420 can include data-processing rules that are configured to prevent unauthorized access to the data object by other systems and networks. For example, the set of data-access protocols generated by the trained machine-learning model can include permissions and access control settings that prevent unauthorized modifications or downloads of the data object.

Iii. Techniques for Determining Data-Access Protocols of Data Objects

As described herein, a set of data-access protocols associated with a data object can be used to prevent unauthorized access to the data object by other systems and networks. The set of data-access protocols can be implemented using identity and access management (IAM) that define policies that grant or restrict access to files based on criteria such as user identity, IP address, or authentication method or encryption techniques that provide encryption keys and access controls to restrict access to sensitive data and prevent unauthorized disclosure or modification.

The set of data-access protocols can be associated with one of various types. For example, the set of data-access protocols can include a location-based protocol, in which the location-based protocol can specify a set of regions for which the data object is authorized to be accessed. In another example, the set of data-access protocols can include a time-based protocol, in which the time-based protocol can specify a time period during which the data object is authorized to be accessed. In yet another example, the set of data-access protocols can include an operation-type protocol, in which the operation-type protocol specifies types of computing operations for which the data object is authorized to be accessed. The set of data-access protocols can additionally include a certificate protocol, in which the certificate protocol identifies one or more applications that were previously authorized to access the data object.

a. Location-Based Protocols

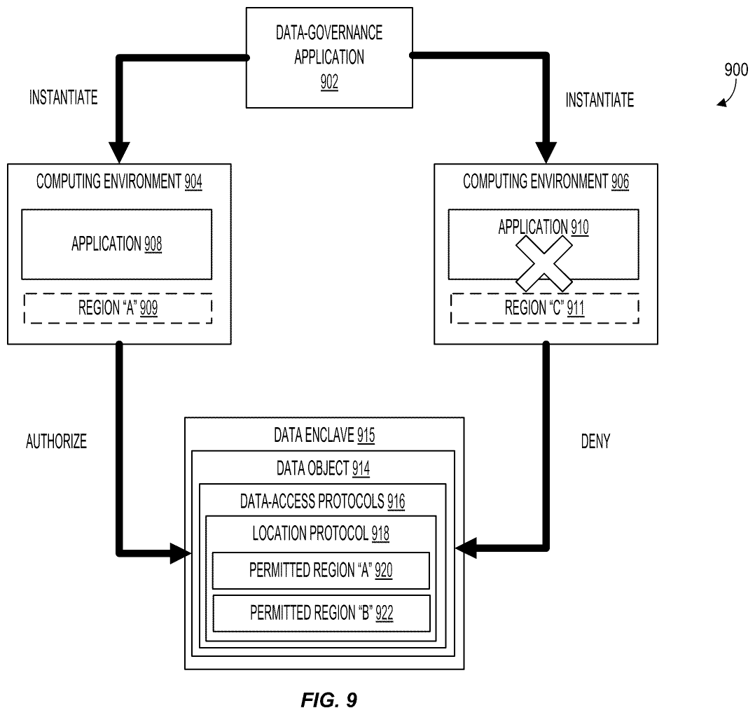

FIG. 9 shows an example schematic diagram 900 for configuring location-based protocols of data objects, in accordance with some embodiments. As shown in FIG. 9, a data-governance application 902 can be configured to implement data-access protocols of data objects associated with computing environments. As described herein, the data-governance application 902 can receive a request to instantiate computing environments 904 and 906. The request can include one or more instructions transmitted by the user device over a communication network to instantiate the computing environments 904 and 906.

The request can identify a data object 914 to be associated with the computing environments 904 and 906. As described herein, the data object 914 can be configured to store different types of information in computer-readable format, which can be used by various devices and systems to perform various computing operations. For example, the data object 914 can include text data, image data, video data, and/or audio data. In some instances, the data object 914 includes computer-executable code such as a binary file, source code, and/or script data. In another example, the data object 914 can correspond to a training dataset that can be used for training one or more machine-learning models. Other examples of the data object 914 can include, but are not limited to, database records, transaction data, sensor data (e.g., temperature sensors, temperature sensor), user-profile data, geospatial data, configuration settings of one or more applications, and server logs. In some instances, the data object 914 is stored in a secured, isolated computing environment, such as a data enclave 915.

The data-governance application 902 can instantiate the computing environments 904 and 906 after receiving the request. For example, the computing environment 904 can include an application 908 running in the computing environment 904. In another example, the computing environment 906 can include an application 910 running in the computing environment 906. Each of the applications 908-910 can perform various types of computing operations, including data processing and analysis, content delivery and media streaming, web application hosting and deployment, and machine-learning classifications.

In some instances, the computing environments 904 and 906 can be associated with one or more location-based characteristics. Examples of the location-based characteristics can include the location at which the computing environment 904 was instantiated or a location of the user device that submitted the request to instantiate the computing environment 906. Continuing with the examples in FIG. 9, the computing environment 904 can be associated with a geographic region “A” 909, and the computing environment 906 can be associated with a geographic region “C” 911.

The data-governance application 902 can identify a set of data-access protocols 916 associated with the data object 914. As described herein, the set of data-access protocols 916 can include data-processing rules that are configured to prevent unauthorized access and modifications to the data object 914 by other systems and networks. As shown in FIG. 9, the set of data-access protocols 916 can include a location-based protocol 918, in which the location-based protocol 918 can specify a permitted region “A” 920 and a permitted region “B” 922 for which the data object 914 is authorized to be accessed. Examples of location-based protocols can include but are not limited to the following:
Geographic Region Restriction: a data-access protocol that restricts access to the data object if the computing environment is running in a specific geographic region, such as a country, city, or continent. The data-access protocol can also restrict access to the data object if the computing environment was instantiated by the user device located in the specific geographic region.
IP Address Blacklisting: a data-access protocol that allows or denies access to the data object based on the IP address of the computing environment.
Network Zone Access Control: a data-access protocol that allows access to the file only if the computing environment is connected to a specific network zone (e.g., an intranet network of an organization).
GPS Coordinates: a data-access protocol that restricts access based on GPS coordinates of the user device that instantiated the computing environment.
VPN Detection: a data-access protocol that allows access to the data object only if the computing environment is connected through a VPN or a proxy server.
Geofencing: a data-access protocol that indicates virtual boundaries around specific geographic areas, within which access to the data object is permitted. In effect, geofencing restricts access to the data object if the computing environment is running outside of these boundaries.
Time Zone Verification: a data-access protocol that allows access to the data object only within specific time zones.

In some instances, to identify the location-based protocol 918, the data-governance application 902 applies a machine-learning model to the data object (and corresponding metadata or description) to generate an output that identifies the location-based protocol 918. Techniques for using machine-learning models to determine the set of protocols are further described in Section II of the present disclosure.

The data-governance application 902 can determine whether one or more characteristics associated with the computing environment 904 or the computing environment 906 comply with the location protocol 918. Referring to the examples of FIG. 9, the data-governance application 902 can determine that one or more time characteristics associated with the computing environment 904 comply with the location protocol 918 based on a determination that the region “A” 909 is listed as one of the permitted regions in the location protocol 918 (i.e., permitted region “A” 920). In another example, the data-governance application 902 can determine that one or more time characteristics associated with the computing environment 906 violate with the location protocol 918 based on a determination that the region “C” 911 is not listed as one of the permitted regions in the location protocol 918.

After determining that the characteristics comply with the location-based protocol 918, the data-governance application 902 can authorize the application 908 of the computing environment 904 to access the data object 914. Conversely, the data-governance application can deny access to the application 910 in the computing environment 906. In some instances, to prevent the data objects from future unauthorized access, the data-governance application deletes the data object 914 after completion of the one or more computing operations.

### B. Time-Based Protocols

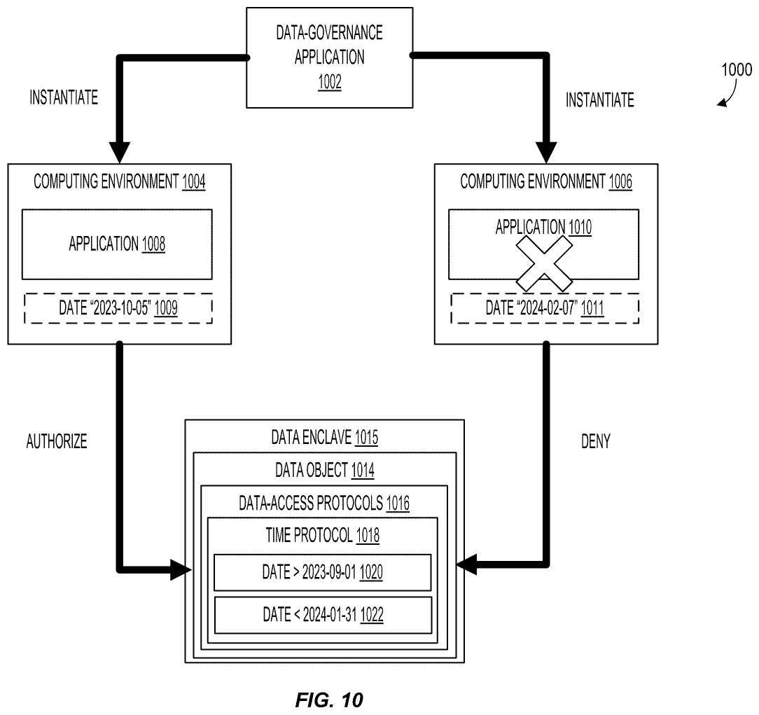

FIG. 10 shows an example schematic diagram 1000 for configuring time-based protocols of data objects, in accordance with some embodiments. As shown in FIG. 10, a data-governance application 1002 can be configured to implement data-access protocols of data objects associated with computing environments. As described herein, the data-governance application 1002 can receive a request to instantiate computing environments 1004 and 1006. The request can include one or more instructions transmitted by the user device over a communication network to instantiate the computing environments 1004 and 1006.

The request can identify a data object 1014 to be associated with the computing environments 1004 and 1006. As described herein, the data object 1014 can be configured to store different types of information in computer-readable format, which can be used by various devices and systems to perform various computing operations. For example, the data object 1014 can include text data, image data, video data, and/or audio data. In some instances, the data object 1014 includes computer-executable code such as a binary file, source code, script data, and training datasets. Other examples of the data object 1014 can include, but are not limited to, database records, transaction data, sensor data (e.g., temperature sensors, temperature sensor), user-profile data, geospatial data, configuration settings of one or more applications, and server logs. In some instances, the data object 1014 is stored in a secured, isolated computing environment, such as a data enclave 1015.

The data-governance application 1002 can instantiate the computing environments 1004 and 1006 after receiving the request. For example, the computing environment 1004 can include an application 1008 running in the computing environment 1004. In another example, the computing environment 1006 can include an application 1010 running in the computing environment 1006. Each of the applications 1008-1010 can perform various types of computing operations, including data processing and analysis, content delivery and media streaming, web application hosting and deployment, and machine-learning classifications.

In some instances, the computing environments 1004 and 1006 can be associated with one or more time-based characteristics. Examples of the time-based characteristics can include the time at which the computing environment 1004 was instantiated. Continuing with the examples in FIG. 10, the computing environment 1004 was instantiated at date “2023-10-15” 1009, and the computing environment 1006 was instantiated at date “2024-02-7” 1011.

The data-governance application 1002 can identify a set of data-access protocols 1016 associated with the data object 1014. As described herein, the set of data-access protocols 1016 can include data-processing rules that are configured to prevent unauthorized access and modifications to the data object 1014 by other systems and networks. As shown in FIG. 10, the set of data-access protocols 1016 can include a time-based protocol 1018, in which the time-based protocol 1018 can specify a permitted time range for which the data object 1014 is authorized to be accessed. For example, the time-based protocol 1018 can permit access to computing environments instantiated on any date after “2023-09-1” 1020 and to computing environments instantiated on any date before “2024-01-31” 1022. Accordingly, any computing environments instantiated outside of the specified time range would be denied access to the data object. Other examples of time-based protocols can include but are not limited to the following:
Expiration Date: a data-access protocol that restricts access to the data object after a specific expiration date has passed. This data-access protocol could be useful for time-sensitive data.
Scheduled Access: a data-access protocol that allows access to the data object only during certain scheduled time windows, such as hour range or specific days of the week.
Version Control: a data-access protocol that restricts access to the data object if the accessing application version is outdated or has known security vulnerabilities.
Audit Trail: a data-access protocol that restricts access to the data object based on the timestamp of previous accesses by the computing environments.
Time Zone Restrictions: a data-access protocol that allows access to the data object based on a time range within a particular time zone.

In some instances, to identify the time-based protocol 1018, the data-governance application 1002 applies a machine-learning model to the data object (and corresponding metadata or description) to generate an output that identifies the time-based protocol 1018. Techniques for using machine-learning models to determine the set of protocols are further described in Section II of the present disclosure.

The data-governance application 1002 can determine whether one or more characteristics associated with the computing environment 1004 or the computing environment 1006 comply with the time-based protocol 1018. Referring to the examples of FIG. 10, the data-governance application 1002 can determine that one or more time characteristics associated with the computing environment 1004 comply with the time-based protocol 1018 based on a determination that the computing environment 1004 was instantiated on “2023-10-5”, which is within the time ranges 1020 and 1022. In another example, the data-governance application 1002 can determine that one or more time characteristics associated with the computing environment 1006 violate with the time-based protocol 1018 based on a determination that the computing environment 1004 was instantiated on “2024-02-7”, which is outside the time ranges 1020 and 1022.

After determining that the characteristics comply with the time-based protocol 1018, the data-governance application 1002 can authorize the application 1008 of the computing environment 1004 to access the data object 1014. Conversely, the data-governance application can deny access to the application 1010 in the computing environment 1006. In some instances, to prevent the data objects from future unauthorized access, the data-governance application deletes the data object 1014 after completion of the one or more computing operations.

### C. Operation-Type Protocols

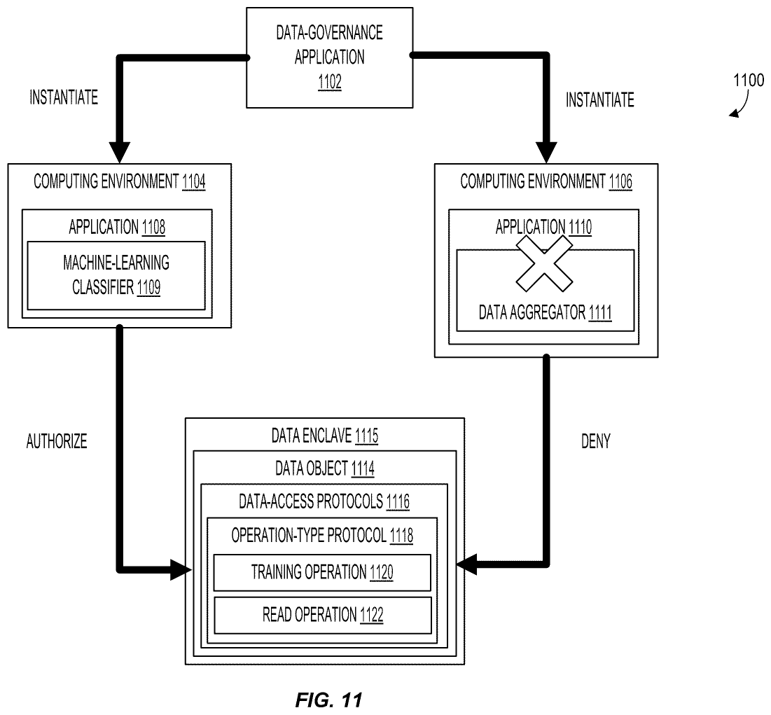

FIG. 11 shows an example schematic diagram 1100 for configuring operation-type protocols of data objects, in accordance with some embodiments. As shown in FIG. 11, a data-governance application 1102 can be configured to implement data-access protocols of data objects associated with computing environments. As described herein, the data-governance application 1102 can receive a request to instantiate computing environments 1104 and 1106. The request can include one or more instructions transmitted by the user device over a communication network to instantiate the computing environments 1104 and 1106.

The request can identify a data object 1114 to be associated with the computing environments 1104 and 1106. As described herein, the data object 1114 can be configured to store different types of information in computer-readable format, which can be used by various devices and systems to perform various computing operations. For example, the data object 1114 can include text data, image data, video data, and/or audio data. In some instances, the data object 1114 includes computer-executable code such as a binary file, source code, script data, and training datasets. Other examples of the data object 1114 can include, but are not limited to, database records, transaction data, sensor data (e.g., temperature sensors, temperature sensor), user-profile data, geospatial data, configuration settings of one or more applications, and server logs. In some instances, the data object 1114 is stored in a secured, isolated computing environment, such as a data enclave 1115.

The data-governance application 1102 can instantiate the computing environments 1104 and 1106 after receiving the request. For example, the computing environment 1104 can include an application 1108 running in the computing environment 1104. In another example, the computing environment 1106 can include an application 1110 running in the computing environment 1106. Each of the applications 1108-1110 can perform various types of computing operations, including data processing and analysis, content delivery and media streaming, web application hosting and deployment, and machine-learning classifications.

In some instances, the applications 1108-1110 can be associated with one or more operation-type characteristics. The operation-type characteristics can identify one or more types of computing operations that are performed by the corresponding application in the computing environment. For example, the operation-type characteristics of the application 1108 can include a machine-learning classifier 1109 which can perform training and deployment of a machine-learning model. In another example, the operation-type characteristics of the application 1110 can include a data aggregator 1111 which can perform collecting and processing personal identifiable information of users to generate customized content.

The data-governance application 1102 can identify a set of data-access protocols 1116 associated with the data object 1114. As described herein, the set of data-access protocols 1116 can include data-processing rules that are configured to prevent unauthorized access and modifications to the data object 1114 by other systems and networks. As shown in FIG. 11, the set of data-access protocols 1116 can include an operation-type protocol 1118, in which the operation-type protocol 1118 can specify types of computing operations for which the applications can perform to access the data object 1114. For example, the operation-type protocol 1118 can permit access to applications performing training operations 1120 and read operations 1122. As a result, any applications that perform computing operations that are not specified by the operation-type protocol 1118 will be prevented from accessing the data object 1114. Other examples of operation-type protocols can include but are not limited to the following:
Data Extraction: a data-access protocol that restricts access to the data object if a specific application attempts to extract sensitive data from the data object, such as personal information or proprietary content.
Model Training: a data-access protocol that allows or restricts access to the data object if a particular application tries to use the data object for training machine learning models.
Data Modification: data-access protocol that allows read-only access to the data object to ensure data integrity and preventing unauthorized changes.
Data Transfer: a data-access protocol that restricts access to the data object if a particular application attempts to transfer the data object to an external location or device, thereby preventing data leakage or unauthorized sharing.
Data Deletion: a data-access protocol that restrict access to the data object if a particular application attempts to delete the data object, thereby protecting against accidental or malicious data loss.
Data Encryption/Decryption: a data-access protocol that allows access to the data object only if the accessing application has the appropriate encryption keys or permissions to decrypt the file.
File Execution: a data-access protocol that restricts access to executable files if an application attempts to execute them, mitigating the risk of running malicious code or unauthorized scripts.
File Sharing: a data-access protocol that restricts access to the data object if an application attempts to share the data object with unauthorized users or external collaborators.
File Printing: a data-access protocol that restricts access to the data object if a particular application attempts to print the contents of the data object.
File Access Logs: a data-access protocol that restricts access to the data object if a particular application attempts to access the data object without logging the operation.

In some instances, to identify the operation-type protocol 1118, the data-governance application 1102 applies a machine-learning model to the data object (and corresponding metadata or description) to generate an output that identifies the operation-type protocol 1118. Techniques for using machine-learning models to determine the set of protocols are further described in Section II of the present disclosure.

The data-governance application 1102 can determine whether one or more characteristics associated with the computing environment 1104 or the computing environment 1106 comply with the operation-type protocol 1118. Referring to the examples of FIG. 11, the data-governance application 1102 can determine that one or more time characteristics associated with the application 1108 comply with the operation-type protocol 1118 based on a determination that the machine-learning classifier 1109 performs training operations that is permitted by the operation-type protocol 1118. In another example, the data-governance application 1102 can determine that one or more operation-type characteristics associated with the application 1110 violate with the operation-type protocol 1118 based on a determination that the data aggregator 1111 performs data extraction and modification of data objects, which is prohibited according to the operation-type protocol 1118.

After determining that the characteristics comply with the operation-type protocol 1118, the data-governance application 1102 can authorize the application 1108 of the computing environment 1104 to access the data object 1114, at which the machine-learning classifier 1109 can use contents of the data object 1114 to train machine-learning models. Conversely, the data-governance application can deny access to the application 1110 in the computing environment 1106. In some instances, to prevent the data objects from future unauthorized access, the data-governance application deletes the data object 1114 after completion of the one or more computing operations.

### IV. Example Systems

FIG. 12 illustrates a computing system architecture 1200, including various components in electrical communication with each other, in accordance with some embodiments. The example computing system architecture 1200 illustrated in FIG. 12 includes a computing device 1202, which has various components in electrical communication with each other using a connection 1206, such as a bus, in accordance with some implementations. The example computing system architecture 1200 includes a processing unit 1204 that is in electrical communication with various system components, using the connection 1206, and including the system memory 1214. In some embodiments, the system memory 1214 includes read-only memory (ROM), random-access memory (RAM), and other such memory technologies including, but not limited to, those described herein. In some embodiments, the example computing system architecture 1200 includes a cache 1208 of high-speed memory connected directly with, in close proximity to, or integrated as part of the processor 1204. The system architecture 1200 can copy data from the memory 1214 and/or the storage device 1210 to the cache 1208 for quick access by the processor 1204. In this way, the cache 1208 can provide a performance boost that decreases or eliminates processor delays in the processor 1204 due to waiting for data. Using modules, methods and services such as those described herein, the processor 1204 can be configured to perform various actions. In some embodiments, the cache 1208 may include multiple types of cache including, for example, level one (L1) and level two (L2) cache. The memory 1214 may be referred to herein as system memory or computer system memory. The memory 1214 may include, at various times, elements of an operating system, one or more applications, data associated with the operating system or the one or more applications, or other such data associated with the computing device 1202.

Other system memory 1214 can be available for use as well. The memory 1214 can include multiple different types of memory with different performance characteristics. The processor 1204 can include any general purpose processor and one or more hardware or software services, such as service 1212 stored in storage device 1210, configured to control the processor 1204 as well as a special-purpose processor where software instructions are incorporated into the actual processor design. The processor 1204 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1204 can be a microprocessor, a microcontroller, a digital signal processor (“DSP”), or a combination of these and/or other types of processors. In some embodiments, the processor 1204 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1200, an input device 1216 can represent any number of input mechanisms, such as a microphone for speech, a touch-sensitive screen for gesture or graphical input, keyboard, mouse, motion input, pen, and other such input devices. An output device 1218 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1200. In some embodiments, the input device 1216 and/or the output device 1218 can be coupled to the computing device 1202 using a remote connection device such as, for example, a communication interface such as the network interface 1220 described herein. In such embodiments, the communication interface can govern and manage the input and output received from the attached input device 1216 and/or output device 1218. As may be contemplated, there is no restriction on operating on any particular hardware arrangement and accordingly the basic features here may easily be substituted for other hardware, software, or firmware arrangements as they are developed.

In some embodiments, the storage device 1210 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1210 can include hardware and/or software services such as service 1212 that can control or configure the processor 1204 to perform one or more functions including, but not limited to, the methods, processes, functions, systems, and services described herein in various embodiments. In some embodiments, the hardware or software services can be implemented as modules. As illustrated in example computing system architecture 1200, the storage device 1210 can be connected to other parts of the computing device 1202 using the system connection 1206. In some embodiments, a hardware service or hardware module such as service 1212, that performs a function can include a software component stored in a non-transitory computer-readable medium that, in connection with the necessary hardware components, such as the processor 1204, connection 1206, cache 1208, storage device 1210, memory 1214, input device 1216, output device 1218, and so forth, can carry out the functions such as those described herein.

The disclosed systems and service of a data-governance application (e.g., the data-governance application 102 described herein at least in connection with FIG. 1) can be performed using a computing system such as the example computing system illustrated in FIG. 12, using one or more components of the example computing system architecture 1200. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for configuring data-access protocols associated with the data-governance application (e.g., the data-governance application described herein at least in connection with FIG. 1) described herein by, for example, executing code using a processor such as processor 1204 wherein the code is stored in memory such as memory 1214 as described herein. One or more of a user device, a provider server or system, a database system, or other such devices, services, or systems may include some or all of the components of the computing system such as the example computing system illustrated in FIG. 12, using one or more components of the example computing system architecture 1200 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1228. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1204 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1214 can be coupled to the processor 1204 by, for example, a connector such as connector 1206, or a bus. As used herein, a connector or bus such as connector 1206 is a communications system that transfers data between components within the computing device 1202 and may, in some embodiments, be used to transfer data between computing devices. The connector 1206 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1214 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1214 can also include magnetic or optical data storage media including read-only (e.g., CD ROM and DVD ROM) or otherwise (e.g., CD or DVD). The memory can be local, remote, or distributed.

As described above, the connector 1206 (or bus) can also couple the processor 1204 to the storage device 1210, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1210. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1206 can also couple the processor 1204 to a network interface device such as the network interface 1220. The interface can include one or more of a modem or other such network interfaces including, but not limited to those described herein. It will be appreciated that the network interface 1220 may be considered to be part of the computing device 1202 or may be separate from the computing device 1202. The network interface 1220 can include one or more of an analog modem, Integrated Services Digital Network (ISDN) modem, cable modem, token ring interface, satellite transmission interface, or other interfaces for coupling a computer system to other computer systems. In some embodiments, the network interface 1220 can include one or more input and/or output (I/O) devices. The I/O devices can include, by way of example but not limitation, input devices such as input device 1216 and/or output devices such as output device 1218. For example, the network interface 1220 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1202 can be connected to one or more additional computing devices such as computing device 1224 via a network 1222 using a connection such as the network interface 1220. In such embodiments, the computing device 1224 may execute one or more services 1226 to perform one or more functions under the control of, or on behalf of, programs and/or services operating on computing device 1202. In some embodiments, a computing device such as computing device 1224 may include one or more of the types of components as described in connection with computing device 1202 including, but not limited to, a processor such as processor 1204, a connection such as connection 1206, a cache such as cache 1208, a storage device such as storage device 1210, memory such as memory 1214, an input device such as input device 1216, and an output device such as output device 1218. In such embodiments, the computing device 1224 can carry out the functions such as those described herein in connection with computing device 1202. In some embodiments, the computing device 1202 can be connected to a plurality of computing devices such as computing device 1224, each of which may also be connected to a plurality of computing devices such as computing device 1224. Such an embodiment may be referred to herein as a distributed computing environment.

The network 1222 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1222 can be wired connections, wireless connections, or combinations thereof. Communications via the network 1222 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1222, within the computing device 1202, within the computing device 1224, or within the computing resources provider 1228 can include information, which also may be referred to herein as content. The information may include text, graphics, audio, video, haptics, and/or any other information that can be provided to a user of the computing device such as the computing device 1202. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1202 and presented to a user of the computing device 1202 using forms that are perceptible via sight, sound, smell, taste, touch, or other such mechanisms. In some embodiments, communications over the network 1222 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1202 and/or the computing device 1224 can be connected to a computing resources provider 1228 via the network 1222 using a network interface such as those described herein (e.g. network interface 1220). In such embodiments, one or more systems (e.g., service 1230 and service 1232) hosted within the computing resources provider 1228 (also referred to herein as within “a computing resources provider environment”) may execute one or more services to perform one or more functions under the control of, or on behalf of, programs and/or services operating on computing device 1202 and/or computing device 1224. Systems such as service 1230 and service 1232 may include one or more computing devices such as those described herein to execute computer code to perform the one or more functions under the control of, or on behalf of, programs and/or services operating on computing device 1202 and/or computing device 1224.

For example, the computing resources provider 1228 may provide a service, operating on service 1230 to store data for the computing device 1202 when, for example, the amount of data that the computing device 1202 exceeds the capacity of storage device 1210. In another example, the computing resources provider 1228 may provide a service to first instantiate a virtual machine (VM) on service 1232, use that VM to access the data stored on service 1232, perform one or more operations on that data, and provide a result of those one or more operations to the computing device 1202. Such operations (e.g., data storage and VM instantiation) may be referred to herein as operating “in the cloud,” “within a cloud computing environment,” or “within a hosted virtual machine environment,” and the computing resources provider 1228 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1228 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1230 and service 1232 may implement versions of various services (e.g., the service 1212 or the service 1226) on behalf of, or under the control of, computing device 1202 and/or computing device 1224. Such implemented versions of various services may involve one or more virtualization techniques so that, for example, it may appear to a user of computing device 1202 that the service 1212 is executing on the computing device 1202 when the service is executing on, for example, service 1230. As may also be contemplated, the various services operating within the computing resources provider 1228 environment may be distributed among various systems within the environment as well as partially distributed onto computing device 1224 and/or computing device 1202.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1202) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 300 of FIG. 3). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1202.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 55 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

6] The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a request to instantiate a computing environment, wherein the request identifies a data object to be associated with the computing environment;
instantiating the computing environment after receiving the request, wherein instantiating the computing environment includes preventing unauthorized access of the data object;
determining that the computing environment is attempting to access the data object to perform one or more computing operations;
identifying a set of data-access protocols associated with the data object;
determining that one or more characteristics associated with the computing environment and the one or more computing operations comply with the set of data-access protocols; and
authorizing the computing environment to access the data object to perform the one or more computing operations.

2. The computer-implemented method of claim 1, wherein the set of data-access protocols includes a location-based protocol, wherein the location-based protocol specifies a set of regions for which the data object is authorized to be accessed, and wherein the one or more characteristics indicate that the computing environment was instantiated at one of the set of regions.

3. The computer-implemented method of claim 1, wherein the set of data-access protocols includes a time-based protocol, wherein the time-based protocol specifies a time period during which the data object is authorized to be accessed, and wherein the one or more characteristics indicate that the computing environment was instantiated within the time period.

4. The computer-implemented method of claim 1, wherein the set of data-access protocols includes an operation-type protocol, wherein the operation-type protocol specifies types of computing operations for which the data object is authorized to be accessed, and wherein the one or more characteristics indicate that the one or more computing operations correspond at least one of the types of computing operations.

5. The computer-implemented method of claim 1, further comprising:
deleting the data object after completion of the one or more computing operations.

6. The computer-implemented method of claim 1, further comprising:
determining that the computing environment is attempting to access the data object to perform a different set of computing operations;
determining that one or more characteristics associated with the different set of computing operations violates the set of data-access protocols; and
denying access of the data object for performing the different set of computing operations.

7. The computer-implemented method of claim 1, wherein the data object includes a training dataset, and wherein the one or more computing operations include using the training dataset to train a machine-learning model.

8. The computer-implemented method of claim 1, wherein the set of data-access protocols prevents modifications or downloading of the data object.

9. A system comprising:
one or more processors; and
memory storing thereon instructions that, as a result of being executed by the one or more processors, cause the system to perform operations comprising:
receiving a request to instantiate a computing environment, wherein the request identifies a data object to be associated with the computing environment;
instantiating the computing environment after receiving the request, wherein instantiating the computing environment includes preventing unauthorized access of the data object;
determining that the computing environment is attempting to access the data object to perform one or more computing operations;
identifying a set of data-access protocols associated with the data object;
determining that one or more characteristics associated with the computing environment and the one or more computing operations comply with the set of data-access protocols; and
authorizing the computing environment to access the data object to perform the one or more computing operations.

10. The system of claim 9, wherein the set of data-access protocols includes a location-based protocol, wherein the location-based protocol specifies a set of regions for which the data object is authorized to be accessed, and wherein the one or more characteristics indicate that the computing environment was instantiated at one of the set of regions.

11. The system of claim 9, wherein the set of data-access protocols includes a time-based protocol, wherein the time-based protocol specifies a time period during which the data object is authorized to be accessed, and wherein the one or more characteristics indicate that the computing environment was instantiated within the time period.

12. The system of claim 9, wherein the set of data-access protocols includes an operation-type protocol, wherein the operation-type protocol specifies types of computing operations for which the data object is authorized to be accessed, and wherein the one or more characteristics indicate that the one or more computing operations correspond at least one of the types of computing operations.

13. The system of claim 9, wherein the instructions further cause the system to perform operations comprising:
deleting the data object after completion of the one or more computing operations.

14. The system of claim 9, wherein the instructions further cause the system to perform operations comprising:
determining that the computing environment is attempting to access the data object to perform a different set of computing operations;
determining that one or more characteristics associated with the different set of computing operations violates the set of data-access protocols; and
denying access of the data object for performing the different set of computing operations.

15. The system of claim 9, wherein the data object includes a training dataset, and wherein the one or more computing operations include using the training dataset to train a machine-learning model.

16. The system of claim 9, wherein the set of data-access protocols prevents modifications or downloading of the data object.

17. A non-transitory, computer-readable storage medium storing thereon executable instructions that, as a result of being executed by one or more processors of a computer system, cause the computer system to perform operations comprising:
receiving a request to instantiate a computing environment, wherein the request identifies a data object to be associated with the computing environment;
instantiating the computing environment after receiving the request, wherein instantiating the computing environment includes preventing unauthorized access of the data object;
determining that the computing environment is attempting to access the data object to perform one or more computing operations;
identifying a set of data-access protocols associated with the data object;
determining that one or more characteristics associated with the computing environment and the one or more computing operations comply with the set of data-access protocols; and
authorizing the computing environment to access the data object to perform the one or more computing operations.

18. The non-transitory, computer-readable storage medium of claim 17, wherein the set of data-access protocols includes a location-based protocol, wherein the location-based protocol specifies a set of regions for which the data object is authorized to be accessed, and wherein the one or more characteristics indicate that the computing environment was instantiated at one of the set of regions.

19. The non-transitory, computer-readable storage medium of claim 17, wherein the set of data-access protocols includes a time-based protocol, wherein the time-based protocol specifies a time period during which the data object is authorized to be accessed, and wherein the one or more characteristics indicate that the computing environment was instantiated within the time period.

20. The non-transitory, computer-readable storage medium of claim 17, wherein the set of data-access protocols includes an operation-type protocol, wherein the operation-type protocol specifies types of computing operations for which the data object is authorized to be accessed, and wherein the one or more characteristics indicate that the one or more computing operations correspond at least one of the types of computing operations.

21. The non-transitory, computer-readable storage medium of claim 17, wherein the executable instructions further cause the computer system to perform operations comprising:
deleting the data object after completion of the one or more computing operations.

22. The non-transitory, computer-readable storage medium of claim 17, wherein the executable instructions further cause the computer system to perform operations comprising:
determining that the computing environment is attempting to access the data object to perform a different set of computing operations;
determining that one or more characteristics associated with the different set of computing operations violates the set of data-access protocols; and
denying access of the data object for performing the different set of computing operations.

23. The non-transitory, computer-readable storage medium of claim 17, wherein the data object includes a training dataset, and wherein the one or more computing operations include using the training dataset to train a machine-learning model.

24. The non-transitory, computer-readable storage medium of claim 17, wherein the set of data-access protocols prevents modifications or downloading of the data object.
